(19) United States
(12) Patent Application Publication
(10) Pub. No.: US 2022/0386669 A1
(43) Pub. Date: Dec. 8, 2022

(54) CANNABIS INFUSED ICE CREAM

(71) Applicant: Nimrod AYZIC, Tel Aviv (IL)

(72) Inventor: Nimrod AYZIC, Tel Aviv (IL)

(21) Appl. No.: 17/800,244

(22) PCT Filed: Jan. 3, 2021
(86) PCT No.: PCT/IL2021/050006

§ 371 Date: Aug. 17, 2022

(30) Foreign Application Priority Data
Feb. 23, 2020 (IL) 272842

(51) Int. Cl. A23L 33/105; A23L 33/125; A23L 27/30; A23G 9/04; A23G 9/42; A23L 29/30

(52) U.S. Cl. CPC A23L 33/105; A23L 33/125; A23L 27/33; A23G 9/04; A23G 9/42; A23L 29/30

(57) ABSTRACT

A method for making cannabis infused ice cream including the steps of weighting liquid raw products, pouring and mixing the weighted liquid raw products to a pasteurizer at a first heating temperature level. Sweeteners are added to the mixture. The mixture is heated to a second temperature level. Adding and mixing the mixture with food stabilizer and with milk powder. Adding and mixing cannabinoids substances associated with medicinal cannabis. The mixture is heated to a fourth temperature level. Afterwards the mixture is immediately cooled to the fifth temperature level. The mixture afterwards is left in a refrigerator for a few hours for the mixture to become more solid. Adding food flavors to the more solid mixture. Mixing and grinding the more solid mixture and creating emulsion. The grinded mixture is added to a barrel freezer of an ice cream machine for making an infused cannabis ice cream.

### FIELD OF THE INVENTION

The present invention relates to methods for preparing ice creams, in particular methods for preparing cannabis infused ice cream.

### BACKGROUND OF THE INVENTION

cannabidiol (CBD) and tetrahydrocannabinol (THC) are two natural compounds found in plants of the Cannabis genus. CBD can be extracted from hemp or from marijuana. Hemp plants are cannabis plants that contain less than 0.3 percent THC, while marijuana plants are cannabis plants that contain higher concentrations of THC. CBD is typically sold in the form of gels, gummies, oils, supplements, extracts, and more. THC is the main psychoactive compound in marijuana that gives the high sensation. It can be consumed by smoking marijuana. It's also available in oils, edibles, tinctures, capsules, and more. Both compounds interact with the human body's endocannabinoid system, but they have very different effects. Despite their similar chemical structures, CBD and THC don't have the same psychoactive effects. In fact, CBD is a non-psychoactive compound. That means it doesn't produce the “high” associated with THC. CBD and THC have many of the same medical benefits. They can provide relief from several of the same conditions. However, CBD doesn't cause the euphoric effects that occur with THC. Some people may prefer to use CBD because of the lack of this side effect.

Methods and systems of the medical cannabis natural compounds contained or processed into foodstuffs or medicinal compounds in controlled ways and with specific characteristics are addressed for example in US20120095088, US9955716, US2012043242 and CN101543294A.

US20120095088 discloses a product and a process where cannabinoids substances associated with medicinal cannabis are contained or processed into foodstuffs or medicinal compounds in controlled ways and with specific characteristics. First a medicinal substance with a known about of medicinal cannabis is mixed into a foodstuff such that the medicinal cannabis is distributed uniformly in the foodstuff. Foodstuffs consistent with this product or process include baked goods, hard candies, ice cream and yogurt. The product is characterized by a controlled number of cannabinoids per unit volume of the foodstuff.

U.S. Pat. No. 9,955,716 discloses a method of manufacturing and packaging frozen ice pops of cannabis juice purée involves collecting raw cannabis material. Next, raw cannabis material is blended with water, fruit juice, or vegetable juice and a sweetening or flavoring agent to form cannabis juice purée. Decarboxylated or non-decarboxylated high concentrate cannabis extract or decarboxylated cannabis infusion is optionally added to the purée. Next, the purée is poured into a tube-shaped plastic container. Next, the container is frozen to obtain a packaged frozen ice pop of cannabis juice purée. The cannabis ice pop is provided singularly or in a package having additional cannabis ice pops. A dispensary can store the ice pops until distribution.

US2012043242 discloses a product and a process wherein Medicinal tetrahydrocannabinol and potentially other cannabinoids (medicinal cannabis substances) associated with decarboxylated cannabis, including yet not necessarily limited to cannbidiols, and cannabigerol are rendered into a fatty foodstuff and then molded into a mold that also acts as a package.

CN101543294A discloses food, prepared with the following raw materials (part by weight): Liquorice, tuckahoe, dandelion, fructus cannabis, mulberry leaves, honey, calipash, honeysuckle, and chrysanthemum. Through mixing with appropriate minor ingredients, these raw materials with the given formula are prepared into beverage, granular formulation, lozenge, ice cream, jelly or instant drink; alternatively, these raw materials with the given formula may be added into bread, pastry or biscuit.

One object of the present invention is to provide a method for preparing ice cream infused with CBD and/or tetrahydrocannabinol THC natural compounds of plants of the Cannabis genus.

Yet another object of the present invention is to provide a method for preparing a variety of cannabis ice creams while maintaining in the ice creams the active ingredients of the cannabis compounds.

### SUMMARY OF THE INVENTION

The present invention relates to methods for preparing ice creams, in particular methods for preparing cannabis infused ice creams.

In accordance with an embodiment of the present invention there is provided a method for making cannabis infused ice cream including the steps of weighting liquid raw products, pouring and mixing the weighted liquid raw products to a pasteurizer at a first heating temperature level. Sweeteners are added to the mixture. The mixture is heated to a second temperature level. Adding and mixing the mixture with food stabilizer and with milk powder. Adding and mixing cannabinoids substances associated with medicinal cannabis. The mixture is heated to a fourth temperature level. Afterwards the mixture is immediately cooled to the fifth temperature level. The mixture afterwards is left in a refrigerator for a few hours for the mixture to become more solid. Adding food flavors to the more solid mixture. Mixing and grinding the more solid mixture and creating emulsion. The grinded mixture is added to a barrel freezer of an ice cream machine for making an infused cannabis ice cream.

### BRIEF DESCRIPTION OF THE DRAWINGS

The invention may be understood upon reading of the following detailed description of non-limiting exemplary embodiments thereof, with reference to the following drawings, in which:

FIG. 1 is a flowchart describing the process for making cannabis infused ice cream in accordance with some embodiments of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

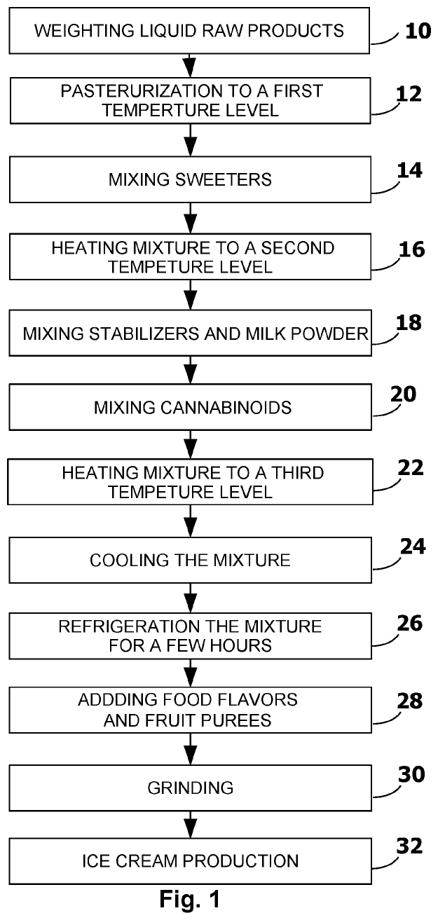

Referring first to FIG. 1, there is shown a flowchart describing the process for making cannabis infused ice cream in accordance with some embodiments of the present invention. In step 10 liquid raw products are weighted such as but not limited to water, milk, cream and milk Substitutes. In step 12 the weighted liquids are poured and mixed to pasteurizer. The liquid mixture preferably heated to a first temperature level of 45° degrees Celsius. In step 14, sweetener of one or more types is mixed to the mixture of step 12. The one or more sweeteners can be selected from a group consisting of dextrose, Glucose powder, white sugar, cane sugar, raw sugar, fructose, turbinado sugar, coconut sugar, date sugar, liquid stevia, liquid sugar, powdered sugar, brown sugar, moscavado sugar, honey, agave and other like sweeteners. In step 16, the liquid mixture of step 14 is heated to a second temperature level, preferably to 50° degrees Celsius. In step 18 adding and mixing the mixture of step 16 with food stabilizer and with milk powder at a third temperature level of 60° degrees Celsius. The food stabilizer can be for example but not limited to Carob flour and guar legume. In step 20 adding and mixing cannabinoids substances associated with medicinal cannabis. In one embodiment of the present invention the cannabinoids substances can be found for example in cannabis oil which is a bio-available, highly metabolizable and fast acting when ingested by a user. The cannabis oil can be selected from the group including THC, CBD and other cannabinoid oils isolated from the marijuana plant. In another embodiment of the present invention the cannabinoids substances can be found for example in a grinded and dried medical cannabis flower. In step 22, the mixture of step 20 is heated to a fourth temperature level, preferably between 88° to 90° degrees Celsius. In step 24 the mixture is immediately cooled down to about 4° to 5° degrees Celsius, preferably in a few seconds and in step 26 the mixture of step 24 is left in the refrigerator for a few hours and becomes more solid. Preferably, the mixture of step 24 is left in the refrigerator for twelve hours for fermentation of the mixture. In step 28 adding food flavors and optionally fruit purees. In step 30, creating emulsion by mixing and grinding the mixture of step 28. In step 32 adding the mixture that is in step 30 to a barrel freezer of typical ice cream machine as known in the art. The mixture is gradually freezing only one part of the water crystals making the mixture harder. During the same time, the ice cream machine also pumps clean air into the ice cream, which by the end will hold over 15% of the ice cream volume. Without that air in its structure, ice cream would be hard as an ice cube. Semi frozen mixture is then can be introduced with the final mix of toppings, such as fruits, nuts, sweets or biscuit mix. At the end, ice cream of the invention is packaged and blast-frozen to the temperature between −30 and −40 degrees Celsius.

It should be noted that this process can used for any suitable ice cream such as but not limited to ice creams with Cocoa Lolotsky, sorbets, suger-free ice creams and vegan ice cream. The method of the present invention can be used also for the making of soft ice cream fused with cannabis where the difference is, by changing the cooling and heating temperatures.

In accordance with the present invention the preferred ratios limits of the solid raw materials in the infused ice cream of the invention in order to maintain the active ingredients of the cannabis in the infused cannabis ice cream are as follows: water should be between 58%-68%, solid food materials should be between 32%-42% where sugar should be between 16%-22%, fat should be between 6%-12%, proteins and lactose should be between 8%-12% other solid food materials such as but not limited to hazelnuts, cocoa, coffee should be between 1%-5%. The term, “solid raw materials” means the materials in the infused ice cream of the invention which are not water excluding the cannabis compounds and the active ingredients of the cannabis compounds.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A method for making cannabis infused ice cream comprising the steps of:
weighting liquid raw products;
pouring and mixing said weighted liquid raw products to a pasteurizer to a first heating temperature level;
adding sweetener to said mixture;
heating said mixture to a second temperature level;
adding and mixing said mixture with food stabilizer and with milk powder;
adding and mixing cannabinoids substances associated with medicinal cannabis;
heating said mixture to a fourth temperature level;
cooling said mixture to a fifth temperature level;
leaving said mixture in a refrigerator for a few hours for said mixture to become more solid;
adding food flavors;
mixing and grinding said more solid mixture and creating emulsion; adding said grinded mixture to a barrel freezer of an ice cream machine.
wherein ratios limits amount of the materials in the infused ice cream of the invention in order to maintain the active ingredients of the cannabis in the infused cannabis ice cream are as follows: water is between 58%-68% and the materials which are not water between 32%-42%.

2. A method for making cannabis infused ice cream according to claim 1, wherein said materials which are not water and their amount comprising, sugar between 16%-22%, fat between 6%-12%, proteins, lactose, minerals and salts is between 8%-12% other solid food materials such as but not limited to hazelnuts, cocoa, coffee is between 1%-5%.

3. A method for making cannabis infused ice cream according to claim 1, wherein said first heating temperature level is of 45° degrees Celsius.

4. A method for making cannabis infused ice cream according to claim 1, wherein said sweetener is selected from a group consisting of dextrose, Glucose powder, white sugar, cane sugar, raw sugar, fructose, turbinado sugar, coconut sugar, date sugar, liquid stevia, liquid sugar, powdered sugar, brown sugar, moscavado sugar, honey, agave and other like sweeteners.

5. A method for making cannabis infused ice cream according to claim 1, wherein said second heating temperature is 50° degrees Celsius.

6. A method for making cannabis infused ice cream according to claim 1, wherein said food stabilizer is selected from a group of Carob flour and guar legume.

7. A method for making cannabis infused ice cream according to claim 1, wherein the addition and mixing of food stabilizer, milk powder and cannabinoids substances to said mixture is at third heating temperature.

8. A method for making cannabis infused ice cream according to claim 6, wherein said third heating temperature is 60° degrees Celsius.

9. A method for making cannabis infused ice cream according to claim 1, wherein said fourth heating temperature is between 88° to 90° degrees Celsius.

10. A method for making cannabis infused ice cream according to claim 1, wherein said cannabinoids substances are found in cannabis oil isolated from the marijuana plant.

11. A method for making cannabis infused ice cream according to claim 1, wherein said cannabinoids substances are found in grinded and dried medical cannabis flowers.

12. A method for making cannabis infused ice cream according to claim 1, wherein after said mixture is heated to said fourth temperature level said mixture is cooled down immediately to said fifth temperature level.

13. A method for making cannabis infused ice cream according to claim 1, wherein said fifth temperature level is between 4° to 5° degrees Celsius.

14. A method for making cannabis infused ice cream according to claim 1, wherein said mixture is left in said refrigerator for twelve hours for said mixture to become more solid.

15. A method for making cannabis infused ice cream according to claim 1, wherein said liquid raw products are water, milk, cream and milk substitutes.
